(19) United States
(12) Patent Application Publication
(10) Pub. No.: US 2026/0228784 A1
(43) Pub. Date: Aug. 6, 2026

(54) MACHINE LEARNING-BASED REVIEW GENERATION

(71) Applicant: Etsy, Inc., Brooklyn, NY (US)

(72) Inventors: Jerome R. Bellegarda, Brooklyn, NY (US); Karl M. Groethe, Brooklyn, NY (US)

(21) Appl. No.: 19/045,157

(22) Filed: Feb. 4, 2025

(51) Int. Cl. G06Q 30/0282; G06Q 30/0601

(52) U.S. Cl. CPC G06Q 30/0282; G06Q 30/0629; G06Q 30/0643

(57) ABSTRACT

Methods, systems, and apparatus, including computer programs encoded on computer storage media, for operating an exchange platform. One of the methods includes obtaining, using a script executing on a user device that displays first search results generated by a search engine for a user, data indicating interactions of the user with one or more items of the first search results; generating, using a trained review generation engine and based on the obtained interaction data, a review that predicts content of a review of at least one of the one or more items generated by the user; updating the search engine using the generated review; and using the updated search engine to generate second search results for the user, wherein the second search results are different than the first search results.

### BACKGROUND

Exchange platforms enable the searching and display of item listings from providers of goods or services. Users of the platforms can obtain goods or services associated with the item listings from the providers.

Item listings can include reviews that are generally provided by user of the exchange platform. Reviews can describe the overall quality of an item listing. For example, five-star reviews may indicate that an item, provider, or other aspect of an item listing, is perceived as high quality and vice versa for a one-star review.

Because it may not be practical for users to read hundreds or even thousands of individual reviews for popular products. Platforms have used generative AI to summarize salient points of a set of reviews, and thereby make them more easily digestible to users. While the summarizing approach can work for listings with lots of reviews, it fails for newer listings or listings with no reviews. Certain types of platforms may have niche products or services. Such platforms may have a higher ratio of different products to unique users compared to platforms with less niche products or services. This increased ratio can decrease the number of interactions per product or service, which may result in fewer reviews per listing and in turn, may make review summarization more challenging or less robust for automated review summarization techniques.

### SUMMARY

This specification describes technologies for generating reviews that can be used (i) as template reviews provided to a user for completion, (ii) as publicly or privately available reviews for item listings that do not have any reviews or a threshold number of reviews, or (iii) to optimize item listing search, e.g., to improve quality or associated rating of user reviews.

Reviews can be generated using implicit signals captured based on a user's interaction with an exchange platform. Implicit signals can include interactions between a buyer and seller, e.g., through conversations using a messaging system of the exchange platform. In some cases, the interactions can capture details, such as if there was an issue with an order or how it was handled, requests for customization of item or service, or shipping or delivery information.

Implicit signals can include one or more of the following: multiple aspects of any conversation between seller and buyer, such as, e.g., whether buyer complained about a specific stage of the transaction, or seller apologized for a delay in shipping; one or more aspects of the offer, such as whether a discount was proposed, or customization was part of the transaction; one or more aspects of the product, such as whether a craftsmanship score is high, or the product involves a download; one or more aspects of a listing, such as the goodness of the description, the quality of the photos, the coverage of the attributes; one or more aspects of a seller/shop, such as the average percentage of returns, or damaged items.

In general, an item can refer to any element available for exchange on an exchange platform. An item can include physical goods or services. Using implicit signals, rather than explicit signals, such as data captured using forms or questionnaires, can help improve the number of generated reviews and the accuracy of generated reviews. Explicit signals, such as forms used to collect user input, can suffer from human biases, like recency or confirmation bias, which can cause a user to provide inaccurate responses. Forms of greater length are less likely to be completed, or completed accurately, than shorter forms. Meanwhile, shorter forms will typically result in less accurate generated reviews compared with longer forms because a review generator has less data from which to tailor the generated review. Implicit signals offer greater accuracy and abundancy than explicit signals and result in a more accurate generated review. Moreover, by using implicit signals, a user can review a generated review after generation as opposed to waiting, after providing form responses, for a review to be generated. This reduced latency increases the number of reviews that can be generated for an exchange platform by reducing the number of users leaving a review generation or validation process due to latency.

In some cases, generated reviews can be used to optimize search algorithms for identifying and providing listings of items of an exchange platform, e.g., in response to a user query. For example, an objective function indicating positivity of generated reviews can be used to optimize a search algorithm. The algorithm can provide different results for different queries, or the same query at different points in time. Adjustments to search can result in improved listing reviews, such as predictive reviews artificially generated or reviews provided by a user that are more positive than if adjustments to search were not made. An objective function can be used to indicate the positivity of predictive reviews. The predictive reviews can be generated by a trained review generator. The reviews can be a prediction of a review that would be generated by a given set of one or more users. The reviews try to predict what an actual user will end up posting at the end of a platform experience (e.g., after obtaining a product or service listed on the platform).

Different configurations of a search algorithm can result in different search results being displayed to a user. Configurations that generate search results that result in more positive predictive reviews can be selected over other configurations that result in less positive reviews. Optimizing for good reviews can capture explicit and latent features that contribute to accuracy of search results. Such features can be present in reviews themselves and utilized in the objective function. The objective function can be used to train one or more models that are robust across a variety of item listing categories and other segmentation variables. Such robustness can be a factor of an objective function being listing-specific agnostic. For example, an algorithm trained to generate more positive reviews can be used for any type of good or service included as an item on an exchange platform.

Using a review-based objective function for optimizing search algorithms can improve search performance compared to traditional techniques that seek to optimize click-through rates or other user signals. Click-through rates can serve as a proxy for user interest in a particular item. Click-through rates can be an inaccurate measure of user interest. Such click-based approaches can lead to search results with items that are visually appealing by substantively incorrect, e.g., for a given search query. By optimizing using the end result of a user's journey on a platform, the review-based optimization can avoid erroneous inputs, such as click rates, that can degrade search algorithm accuracy over time.

In some cases, using review-based objective functions can allow modeling of potential reviews for items, e.g., items or services where there is little or no click-through data, such as more niche items or services. Using review-based objective functions can improve search on platforms with more niche items or services compared to traditional click-through rate optimization. Using review-based objective functions can improve accuracy in generating accurate search results, e.g., search results that are responsive to a user query. If there are a mix of niche and more common items or services, the more common items or services may have significantly higher click through or purchase rates which can cause inaccuracies in traditional systems, e.g., skewing search towards those common items.

In general, click-through rate can be a noisy signal that can be skewed by factors unrelated to a quality or relevance of an item or service. Click-through rate can be skewed by things like click-bait imagery or bot interactions. Review signals can capture deeper information about a listing, such as actual buyer interactions which can represent an entire exchange platform use experience. Review signals can be used as input for one or more review-based objective functions. Using review-based objective functions can improve search on platforms compared to systems that us conversion rates, or solely use conversion rates. Conversion rate can suffer from only taking into account an initial interaction or purchase behavior of a user and can leave out post-interaction or post-purchase experience information, e.g., which can cause a skew toward only the pre-purchase or pre-interaction signals.

Techniques can include a variety of review generators. Review generators can include one or more machine learning models trained to generate reviews meant to emulate a real-person review of an item listing. Reviews can include one or more of a rating indicating an overall quality of a listing and a text portion describing in a language of an exchange platform the listing or a process of searching, finding, receiving, or returning a product or service of an item listing. Other things can be described, such as communications with a provider. Reviews can be generated using implicit signals captured based on interaction data with a user of an exchange platform.

A review generator can include a large language model (LLM) configured to obtain quality signals, such as implicit signals from one or more users interacting with one or more item listings. Quality signals can be embedded in a prompt to an LLM, e.g., using one or more automated processes that extract data from one or more interactions and embed features of the interactions into a prompt. Such prompt input can be an automated form of prompt engineering. By automating the generation of prompts using user interactions with the platform, the resource intensive task of manual prompt generation or manual review writing can be eliminated. The LLM can generate an artificial review based on a received prompt. A review can be predictive for a given user and can be updated over time, e.g., based on additional interaction data of the user or another user or updates to an item listing. A prompt for an LLM could be constructed to include signals such as listing content. Few-shot instances of suitably formatted reviews can be used to tailor responses of the LLM. Prompts can be used with existing LLMs.

As an alternative to using existing LLMs, techniques can include training review generators, e.g., from scratch or from a partially trained state. Techniques described include both a supervised learning process of training a review generator, e.g., from a large set of (input signals, review) pairs, and an unsupervised training, e.g., that uses generative adversarial networks (GANs). Review generators, trained using supervised or unsupervised training techniques, can occupy less memory than LLMs. Such generators can reduce energy use compared to LLMs. Such generators can reduce a latency time between request and generated output compared to LLMs. Such generators can provide the same or improved accuracy compared to LLMs. Such generators can reduce a likelihood of hallucinations which can be an element of some LLM output.

In some cases, there is a disconnect in how users engage and how search algorithms work. In some instances, search algorithms find items that are relevant but don't necessarily account for reviews. Even if reviews are factored in search and retrieval operations, certain types of exchange platforms (particularly for niche products or services), might not have enough traffic or volume to generate a sufficient number of reviews. Artificial reviews can be used to optimize search and retrieval of items which otherwise might not be surfaced. For example, a system can gather reviews and use them, e.g., for optimizing search. Techniques can be especially helpful for listings of a lower traffic platform where reviews might not be as abundant as other platforms offering more mass consumer products or services.

In general, one innovative aspect of the subject matter described in this specification can be embodied in methods that include the actions of obtaining, using a script executing on a user device that displays first search results generated by a search engine for a user, data indicating interactions of the user with one or more items of the first search results; generating, using a trained review generation engine and based on the obtained interaction data, a review that predicts content of a review of at least one of the one or more items generated by the user; updating the search engine using the generated review; and using the updated search engine to generate second search results for the user, wherein the second search results are different than the first search results. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: Using the updated search engine to generate second search results for the user comprises: obtaining item listings using a query analyzer engine in response to a user query; and ranking the obtained item listings using a ranking engine. Feature 2: The ranking engine uses the generated review to rank the obtained item listings. Feature 3: The query analyzer engine uses the generated review to obtain the item listings. Feature 4: Generating the review occurs during a same session as the display of the first search results. Feature 5: Obtaining the interaction data comprises: obtaining a signal indicating a user selection on a graphical user interface (GUI) of the user device. Feature 6: Obtaining the interaction data comprises: obtaining a signal indicating a mouse hovering over a portion of a graphical user interface (GUI) of the user device. Feature 7: Obtaining the interaction data comprises: obtaining at least one or more of the following: listing content, quality signals indicative of user interactions with the one or more items of the first search results, lister identification for the one or more items of the first search results, conversations between the user and lister for the one or more items of the first search results, shipping information, delivery information, search queries, search queries within a time range, or search queries within the same session. Feature 8: Actions include training the review generation engine using a supervised learning technique. Feature 9: The actions include training the review generation engine using an unsupervised learning technique. Feature 10: Training the review generation engine comprises: using a discriminator network to determine whether reviews generated by the review generation engine were generated by humans or not. Feature 11: The generated review includes a written portion in a language of the user. Feature 12: The generated review includes a rating portion indicating a rating of the at least one of the one or more items. Feature 13: Updating the search engine using the generated review comprises adjusting one or more parameters of the search engine. Feature 14: Actions include receiving a first query and generating the first search results in response to receiving the first query; and receiving a second query and generating the second search results in response to receiving the second query, wherein the first query and the second query are the same. Feature 15: Actions include providing the second search results to the user device.

In general, one innovative aspect of the subject matter described in this specification can be embodied in methods that include the actions of generating, using a trained review generation engine and based on obtained interaction data, a review that predicts content of a review for one or more items on an exchange platform; providing data indicating the generated review to a first user device, wherein the data includes completed elements for a review of an item; obtaining, from the first user device, a final review, wherein the final review is a modified version of the generated review; storing the final review in memory corresponding to the item on the exchange platform; and providing the final review to a second user device in response to the second user device navigating to a review section on a listing page for the item. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: Actions include training the review generation engine using a supervised learning technique. Feature 2: Actions include training the review generation engine using an unsupervised learning technique. Feature 3: The generated review includes a written portion in a language of the user. Feature 4: The generated review includes a rating portion indicating a rating of the at least one of the one or more items. Feature 5: The generated review includes a review portion that is the same as a review portion of the final review.

In general, one innovative aspect of the subject matter described in this specification can be embodied in methods that include the actions of obtaining, using a script executing on one or more user devices that display an item listing, data indicating interactions of one or more users with the item listing; generating, using a trained review generation engine and based on the obtained interaction data, a review that predicts content of a review for the item listing; storing the generated review in memory corresponding to the item listing on the exchange platform; in response to a search query, obtaining, by a trained search engine, data including the stored generated review of the item listing; providing search results generated by the trained search engine to a user device, wherein the search results include the item listing; and in response to a request by the user device for reviews of the item listing, providing a set of reviews that does not include the generated review. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: Obtaining the interaction data comprises: obtaining a signal indicating a user selection on a graphical user interface (GUI) of the user device. Feature 2: Obtaining the interaction data comprises: obtaining a signal indicating a mouse hovering over a portion of a graphical user interface (GUI) of the user device. Feature 3: Actions include training the review generation engine using a supervised learning technique. Feature 4: Actions include training the review generation engine using an unsupervised learning technique. Feature 5: The generated review includes a written portion in a language of the user. Feature 6: The generated review includes a rating portion indicating a rating of the at least one of the one or more items. Feature 7: Storing the generated review in memory corresponding to the item listing on the exchange platform comprises: storing the generated review in memory with a data element that indicates the generated review has first display settings when a user requests to view reviews for the item listing on the exchange platform.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example exchange platform system.

FIG. 2 is an example process of adjusting search results using generated reviews in more detail.

FIG. 3A is a diagram showing an example process of search result optimization.

FIG. 3B is a diagram showing an example process of generating template reviews.

FIG. 3C is a diagram showing an example process of generating reviews for a listing with no or few reviews.

FIGS. 4A and 4B show different training methods for training a review generator.

Like reference numbers and designations in the various drawings indicate like elements.

### DETAILED DESCRIPTION

Techniques can include generating a machine learning model configured to generate reviews using implicit signals obtained from one or more users on an exchange platform over the course of one or more user sessions. In some cases, the model is configured to generate reviews using implicit signals and not based on explicit human feedback, e.g., submitting responses to forms or questions configured for training a model. For a given user session, an exchange platform can obtain a set of implicit signals associated with the session, such as items selected, clicked, or otherwise viewed. Implicit signals can also include data that describes item listings with which a user interacts, e.g., item listing information or lister information. Implicit signals can include data describing exchanges between users and listers, such as chat conversations where a user asked about a particular item listing. Implicit signals can include data of one or more purchases, shipping, or delivery information.

An exchange platform can obtain implicit signals and generate a review corresponding to a user. The generated review can be a prediction of what the review would be for a given item listing if the user were to write such a review. The platform can use one or more items of data obtained up until that point as input data for a model to generate such a review. In some implementations, generating a review can also include generating a predicted rating which can indicate if the generated review is positive or negative, thus indicating if a user is likely to prefer one item listing over another.

In some cases, a search update engine can be used to update a search process to increase positivity of reviews, e.g., as indicated by words of a review, a rating included in a review, or a combination of one or both of these. For example, an update engine can adjust search results in such a way that, if a user left a review for a given item listing, that review would improve compared to a review generated without the adjustment to the search results. An update engine can update search results to improve a likely review of a specific item listing with which a user has interacted with or to improve an average likely review for one or more item listings. For example, before an update, search results can include a first set of item listings in response to a search query. A review generator can generate reviews for one or more listings of the first set of item listings. The generated reviews can predict how one or more users, or a specific user, would review the given one or more item listings if they would write a review at that moment. An update engine can adjust the search results, or subsequent search results, to improve review quality—e.g., so a specific item is likely to be reviewed more favorably or an average of one or more items are likely to be reviewed more favorably. Favorability can indicate if a user would be more or less happy with an item listing compared to one or more other item listings. Reviews can indicate item functionality, price, customization possibilities, delivery options, among others which can indicate favorability. Updates can include including a different set of item listings or rearranging one or more item listings from an initial set of search results. Updates can include modifying both retrieval and ranking stages of search to show one or more item listings that tend to improve review quality and corresponding user satisfaction.

Data can be obtained from users after updates are made to adjust search results. For example, an update engine can update search results. A user can interact with item listings of the updated search results. An exchange platform can obtain data indicating such interactions as implicit signals for subsequent review generation. Interactions can include clicking on an item listing, adding a listing to cart, favoriting, viewing, among others. Data obtained from updated search results can be used to further update search—e.g., to increase quality of reviews for a given set of one or more items. In general, search results can be influenced toward producing more favorable reviews. In some cases, generated reviews that satisfy a threshold indicate that no additional search updates are required. For example, if an average generated review for a set of search results satisfies a threshold, an update engine can be bypassed and the search results can be provided as is, or subsequent results can be provided using the same search models or processes. In some cases, reviews can be generated and compared to a threshold rating and updates can be applied or not depending on whether or not the threshold is satisfied by one or more item listing reviews.

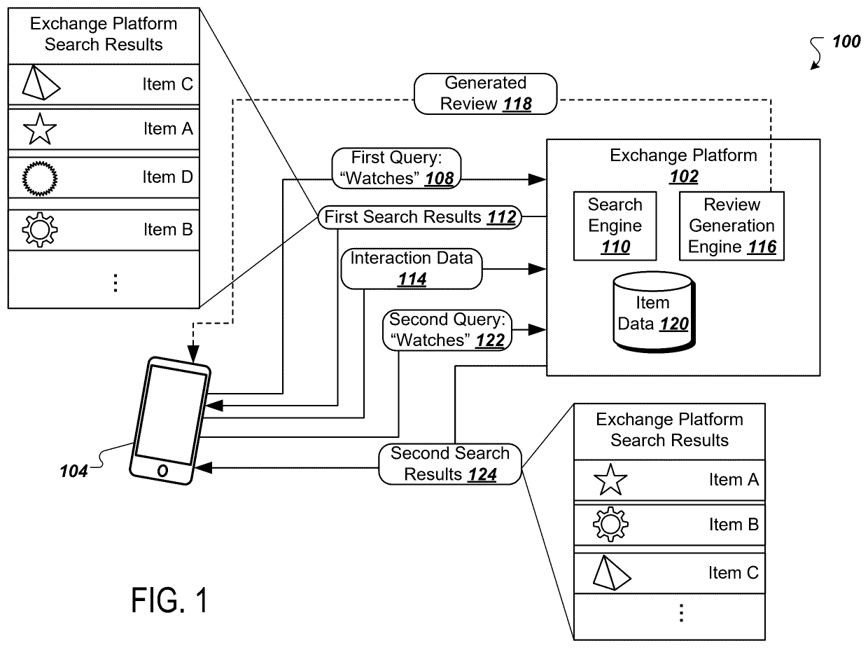

FIG. 1 shows an example exchange platform system 100. The system 100 includes an exchange platform 102 and a device 104. The exchange platform 102 and the device 104 can be communicably connected. The exchange platform 102 can perform operations using input provided by the device 104 and the exchange platform 102 can provided data to the device 104 based on the performed operations. The exchange platform 102 can operate at least partially on the device 104. The exchange platform 102 can operate at least partially on one or more computers communicably connected to the device 104.

In the example of FIG. 1, the device 104 provides a first query 108 to the exchange platform 102. The first query 108 can include a text-based query, such as “WATCHES,” indicating that a user of the device 104 is searching for item listings available on the exchange platform 102 related to watches. A search engine 110 can be used to find item listings that correspond to the first query 108. The found listings can be provided by the exchange platform 102 back to the device 104 as first search results 112. As shown, the first search results 112 include a ranked list of items.

The device 104 can be used to display the first search results 112, e.g., using a screen of the device 104 (and within an application, e.g., a browser, executing on the device 104). The device 104 can be a smartphone, computer, or other suitable device. The device 104 provides interaction data 114 to the exchange platform 102. The interaction data 114 can include interactions by a user of the device 104 with the first search results 112, such as clicks, views, view duration, scrolling, favorites, rating, bookmarks, among others.

A review generation engine 116 is used by the exchange platform 102 to generate reviews. The review generation engine 116 can include one or more machine learning models. The review generation engine 116 can obtain the interaction data 114 that can be used to generate one or more reviews based on the interaction data 114. For example, the review generation engine 116 can generate a review for one or more items of the items included in the first search results 112. The exchange platform 102 can use the generated reviews (i) as template reviews provided to a user for completion—e.g., as generated review 118, (ii) as publicly or privately available reviews for item listings that do not have any reviews or a threshold number of reviews, or (iii) to optimize item listing search, e.g., to improve quality or associated rating of user reviews. In some cases, the review generation engine 116 uses item data 120. The item data 120 can include data stored for one or more item listings, such as one or more item listings of the first search results 112. The item data 120 can include a title for an item listing, images, feature vectors describing aspects of a listing, lister, or user, among others.

In some cases, the exchange platform 102 uses one or more generated reviews to update search results. For example, the device 104 can provide a second query 122 to the exchange platform 102. The second query 122 can include any type of query, e.g., a text-based query for “WATCHES” again. The second query 122 can include a user selection to navigate to a next page of search results. New search results from the second query 122 can be generated using interactions obtained from prior shown results, such as results shown on a first results page. In some cases, non-text-based queries, such as images or audio searches can be obtained and processed by the exchange platform 102. The exchange platform 102 can obtain the second query 122 and provide corresponding data to the search engine 110 to provide second search results 124 to the device 104. The second search results 124 can be altered compared to the first search results 112. For example, as shown, item A is now ranked above item C and item D has been removed. Modification of the search results can be based on reviews generated by the review generation engine 116, e.g., based on the interaction data 114.

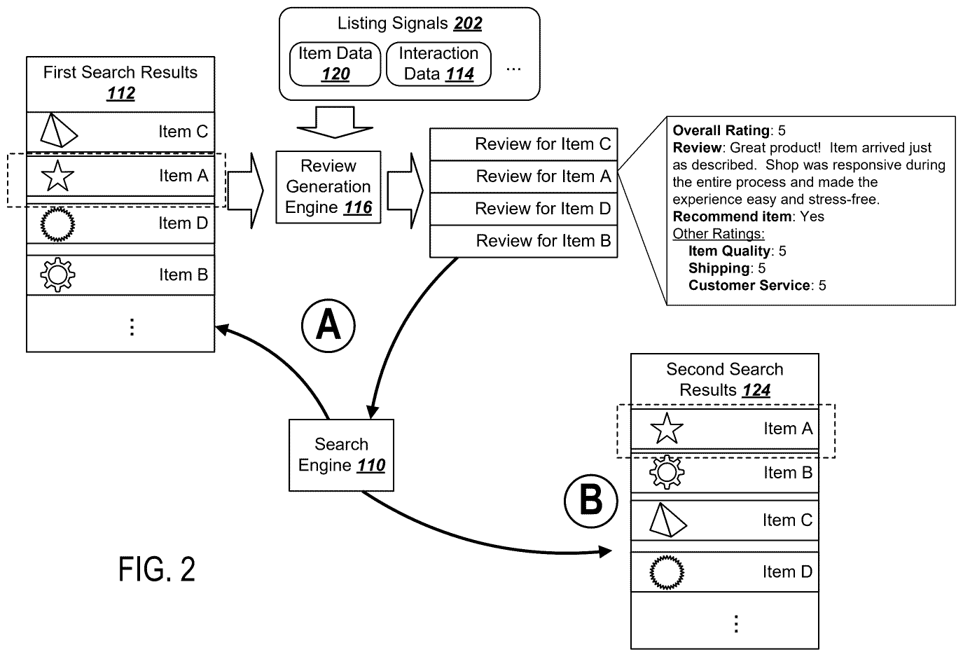

FIG. 2 shows a process of adjusting search results using generated reviews in more detail. The search engine 110, the first search results 112, the review generation engine 116, and the second search results 124 are reused from the system 100 of FIG. 1 to help show, in more detail, an example adjustment used to generate the second search results 124. For example, the search engine 110 can provide the first search results 112 to the review generation engine 116. The review generation engine 116 can obtain listing signals 202, which can include at least a portion of the item data 120 and the interaction data 114, e.g., a listing title from the item data 120 and a set of one or more interactions from the interaction data 114. The review generation engine 116 can then generate, using the listing signals 202, reviews for one or more items of the first search results 112, e.g., a review for item A as shown.

A review can include one or more elements, such as an overall rating, textual based review, recommendation, item quality rating, shipping rating, customer service rating, among others. In some cases, reviews are generated for one or more items in a search result set, e.g., a first ten items. In some cases, the exchange platform 102 selects a subset of items from a search result and generates reviews for one or more of the subset. The subset can include items that have no reviews generated by a user or no reviews. In some cases, the review generation engine 116 generates reviews for a first number of most relevant results based on a user search query on an exchange platform, e.g., results from the most relevant two pages of search results. The generated reviews can then be used, at least in part, to rank or rearrange results. In some cases, each item or service corresponding to a search result includes at least one review signal. Reviews can be generated by the review generation engine 116, e.g., as discussed in reference to FIG. 1. In some cases, reviews are pre-generated off-line for every item in inventory, e.g., pre-generated reviews can be used for generating the first search results 112. Pre-generated reviews can be generated after an item is listed on an exchange platform but before a user submits a query with which the platform generates results using generated reviews.

In some implementations, reviews are generated for all items on an exchange platform. In some implementations, reviews are generated for a subset of items on an exchange platform. The exchange platform 102 can generate reviews for more items when more processing resources are available and generated reviews for less items when less processing resources are available. In general, the exchange platform 102 can be more likely to generate reviews for items of categories associated with low review rates or newer items that may not have reviews or a threshold number of reviews. If used for seed generation, the exchange platform 102 can generate reviews for an item that is likely to be delivered or made available to a requester within a threshold time period, e.g., so that a seed review at least partially generated by the exchange platform 102 can be made available to a user for completion.

Selection of a subset of items can be done using taxonomy categories, review counts for items, or a combination of both, among others. For example, the exchange platform 102 can select a subset of items by identifying a category of one or more items and comparing the identified category to one or more target categories. In response to determining that the identified category matches the one or more target categories, the exchange platform 102 can generate a review for one or more of the one or more items. The exchange platform 102 can select a subset of items by identifying a review count of one or more items and comparing the identified review count to a review count target or targets. In response to determining that a review count of an identified item satisfies the target or targets, the exchange platform 102 can generate a review for the identified item.

Generated reviews are then used to update results of the search engine 110. The search engine 110 can obtain reviews generated by the review generation engine 116. For example, an update portion of the search engine 110 can obtain one or more generated reviews and use the obtained reviews to update the search engine 110. The updates can include adjustments to ranking or searching processes, e.g., using information obtained from one or more generated reviews. The updates can include promoting listings with positive reviews. The updates can include filtering or downlinking listings with poor reviews. The updates can include adjusting which keywords in a query generate specific items or services of query results, e.g., where additional keywords for a given item or service can be determined using a generated review for that item or service or an item or service of a similar type An updated version of the search engine 110 can then generate the second search results 124. As shown, the second search results 124 is different from the first search results 112. In general, differences can include one or more of different item listings or a different ranking of one or more same item listings.

In some cases, traditional update processes for searching may not effectively use review information across sets of items, e.g., due to at least some of the items not having reviews generated. Techniques described allow search improvements using generated reviews to allow for review-based search optimization across sets of items that may not have a threshold number or any user reviews. Items that may not have a threshold number or any user reviews may still have one or more signals sufficient to generate a review, e.g. using a review generation engine, such as the review generation engine 116.

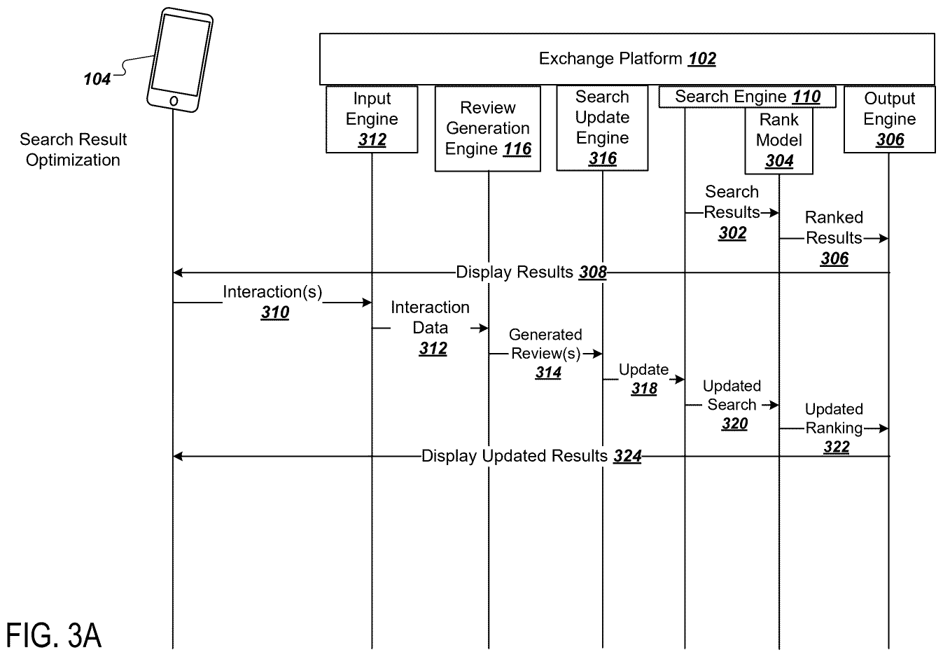

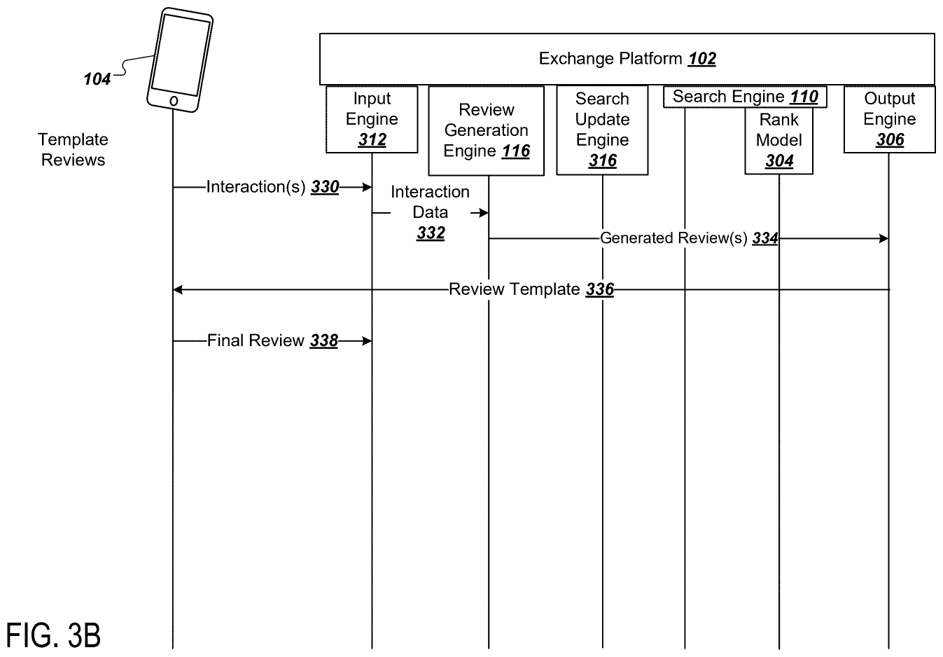

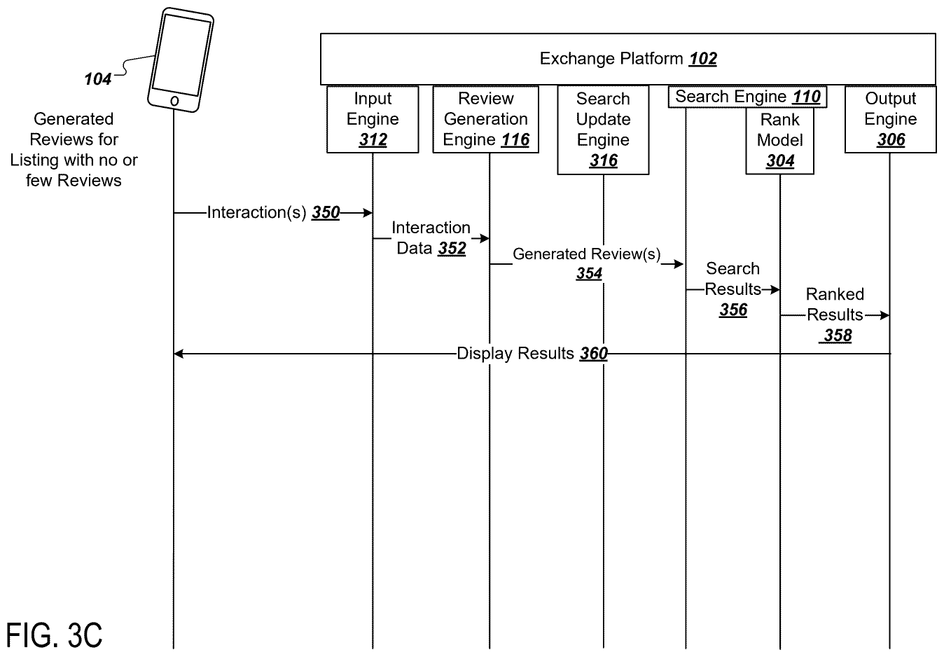

FIG. 3A is a diagram showing an example process of search result optimization. The device 104 interacts with the exchange platform 102 and allows the exchange platform 102 to use such interactions to optimize search results.

In more detail, the search engine 110 generates search results 302. This can be search results in response to a query received from the device 104, such as items from the first search results 112. The search results 302 are provided to a rank model 304 configured to rank the search results 302. Generated ranked results 306 can be similar to the ranked list of first search results 112, as shown in FIG. 1.

In some cases, the rank model 304 is included in the search engine 110. For example, the search engine 110 can search by ranking items and provide search results as a ranked set. In some cases, the search engine 110 includes one or more models trained for searching items and separate one or more models trained for ranking items returned from the search models. By separating the ranking from the searching, results can be further optimized, e.g., by adjusting ranking during a user web session based on received user feedback.

The ranked results 306 are provided to an output engine 306 as display results 308. The output engine 306 can be configured to provide data indicating the display results 308 to the user device 104. The output engine 306 can include performing operations that generate and transmit signals from one or more servers to the user device 104, where the signals indicate the display results 308.

The user device 104 can include input devices configured to obtain input interactions 310 from a user. The interactions 310 can be provided by the device 104 to the exchange platform 102 using an input engine 312. The input engine 312 can perform operations that include receiving one or more signals, such as radio frequency signals, from the device 104. The input engine 312 can be configured to process received data, indicating the interactions 310, and provide corresponding interaction data 312 to the review generation engine 116.

The review generation engine 116 can provide generated reviews 314 to a search update engine 316. The search update engine 316 can obtain the generated reviews 314 and update the search engine 110, e.g., by adjusting one or more parameters or weights of one or more models that perform operations for the search engine 110. Such an update can be transmitted as update 318 to the search engine 110, e.g., a command for changing one or more parameters of one or more models of the search engine 110, where the changes are configured to adjust search results provided by the search engine 110 either for a subsequent query or a previously generated set of results. The update 318 can update one or more elements of the search engine 110, e.g., one or more of a search process or ranking process. The updated 318 can include updates to underlying data used to train one or more models, textual information, or properties, such as number of available reviews, star ratings for reviews, associated with an item listing. Updates can include adding a rank penalty to account for a difference in review ratings between originally ranked items, e.g., producing a different ranking for the output of the search engine based on the rank penalty factor.

If one item in a set of items returned from a search query would generate a bad review, then this can be a signal used by the exchange platform 102 to rank the item lower, and vice versa. In the example of FIG. 2, if Item C would lead to a bad generated review (e.g., because of a high percentage of returns), then it would be demoted to rank 3 in the second search results 124. Demotion can depend on implementation of a review generation objective function. The objective function can include one or more ranking penalties, e.g., to account for a bad review or other negative signal associated with an item.

In some cases, the search engine 110 can be configured to provide item listing relevant to user search queries. The search engine 110 can be configured to retrieve one or more items and rank the one or more items. Retrieval can include techniques such as keyword matching where review text can be indexed and searched for terms matching the query. Retrieval can include other techniques, used instead or in addition to keyword matching. For example, retrieval can include using one or more embedding models, e.g., where product and review information are encoded into vector representations. Review text can be incorporated into embeddings to allow for a potentially richer or more nuanced understanding of the product compared to keyword matching.

In some implementations, ranking is performed by the search engine 110 after retrieval. Ranking can include ordering retrieved items, e.g., based on one or more of factors. Review information can be used to adjust a ranking score of an item. Items with higher average ratings or more positive sentiment in their reviews can be boosted towards the top of results. Items with lower ratings or negative feedback can be pushed further down a list of results. This can help ensure that users are presented with relevant and more positively reviewed products first within search results. Review information can also be used, e.g., by the search engine 110, to influence results by direct suppression or boosting of results with negative or positive review results.

The search engine 110 performs an updated search 320. The updated search 320 can be performed subsequent to updates provided by the update 318. In some cases, the update 318 can adjust a searching element of the searching engine 110 to generate different search results for a same query, e.g., different results compared to the search results 302 for a same query. The rank model 304 can be updated using the update 318. In some cases, only the rank model 304 is updated. For example, one element of the search engine 110 can be updated and other elements of the search engine 110 can remain the same based on the update 318. After generation of the update 318, the rank model 304 can generate the updated ranking 322 which can include a ranking of the updated search 320. In some cases, the updated search 320 matches the search results 302. For example, the update 318 can update the rank model 304 and not a searching process, including one or more models trained for searching, of the search engine 110.

The search engine 110 provides the updated ranking 322 to the output engine 306 and the output engine, similar to the display results 308, can provide the updated display results 324 to the device 104.

FIG. 3B is a diagram showing an example process of generating template reviews. The device 104 interacts with the exchange platform 102 and the exchange platform 102 generates template reviews for a user of the device 104 to complete and post on the exchange platform 102.

In more detail, the device 104 includes input interfaces configured to obtain interactions 330 from a user which are provided by the device 104 to the input engine 312. In some implementations, interaction signals are collected using scripts running on a page provided by the platform 102 to the device 104. The input engine 312 provides data indicating the interactions 330 to the review generation engine 116. In some cases, interaction data can be specifically formatted data that indicates the interactions. In some cases, interaction data is a digital representation of analog data, such as RF data, representing interactions obtained from a transmission provided by the device 104 to the exchange platform 102.

The review generation engine 116 generates reviews 334 and provides the generated reviews 334 to the output engine 306. The output engine provides data indicating the generated reviews 334 as the review template 336 to the device 304. The review template 336 can be an altered version of the reviews 334 or can include additional data indicating what the reviews are and what a user is supposed to do with it. For example, the review template 336 can include instruction data that instructs a user of the device 104 to review and add additional detail to a generated review 334. The review template 336 can include at least a portion of a review that is predictive of a given user or one or more users. For example, the review template 336 can include details similar to the example review shown in FIG. 2 for the item A. In some cases, the review template 336 is a complete review. In some cases, the review template 336 includes portions completed and other portions not completed.

The device 104 receives the review template 336. Receiving can include one or more of display interfaces or analog to digital conversions. The device 104 can display the review template 336 for a user to review and edit. The device 104 can include interfaces configured to allow a user to edit, e.g., by typing, dictating, or making selections, the review template 336. The device 104 provides a final review 338 to the input engine 312. For example, the device 104 can provide an edited version of the review template 336 indicating one or more of the generated reviews 334 or can provide an unedited version, e.g., where a user does not make any changes and provides a generated review as is. The input engine 312 can receive the final review 338 and add it to a corresponding item listing. Adding to an item listing can include adding the final review 338 as a review for an item listing. In some cases, the final review 338 can be included in the item data 120, e.g., and used for subsequent review generation.

FIG. 3C is a diagram showing an example process of generating reviews for a listing with no or few reviews. Item listings with few reviews can include item listings with reviews less or equal to a threshold amount, e.g., ten. The device 104 interacts with the exchange platform 102 and the exchange platform 102 generates reviews that can be used by the exchange platform, e.g., for search result generation. Generation of reviews using the review generation engine 116 can help provide additional, or alternative data, for search processes. For example, the exchange platform 102 can use data associated with item listings for searching and ranking one or more item listings. In some cases, a search process uses reviews to search or rank items, e.g., ranking items with better or more reviews higher than other items or obtained a search result set of items that includes items with specific review attributes. In some implementations, content of reviews can be extracted and used for updating search results. For example, existing reviews of items or reviews generated by the review generation engine 116 can include content indicating the quality of a given item on the platform 102. Searching and ranking processes can use content extracted from reviews to determine items to include in search results or a ranking for a given search result item. Techniques based on quantity of reviews can work better for items with more reviews compared to items with fewer reviews. The process shown in FIG. 3C can be used to generate reviews to improve search or other aspects of a platform using generated reviews, e.g., reviews generated using one or more models of the review generation engine 116. Generated reviews can be particularly useful for platforms that provide niche products or services which, due to a higher ratio of product types or listings to users compared to other platforms, can have fewer reviews per items or a greater number of unreviewed items. Reviews can be generated to optimize search. Such generated reviews can be predictive because they represent a prediction of a given user or users likely review based on interaction data. Actual reviews can also be used to optimize search. Actual reviews can include user-generated reviews from scratch or based on prompt engineering as described in this specification. Generated reviews can also be used with, or instead of, actual user reviews for optimizing search. For example, generated reviews indicating positivity can be included in more search results, be ranked higher, or a combination of these compared to reviews indicating negativity.

In more detail, the device 104 provides interactions 350 to the input engine 312. The input engine 312 provides interaction data 352 corresponding to the interactions 350 to the review generation engine 116. The review generation engine 116 provides generated reviews 354 to the search engine 110. The generated reviews can include reviews for items that have no reviews or with a number of reviews that satisfies a threshold. For example, the exchange platform 102 can identify one or more items that have no reviews or a number of reviews that satisfies a threshold. The exchange platform 102 can obtain interaction data for the one or more items, after identification or before identification, as the interaction data 352. The review generation engine 116 can then be used to generate the reviews 354 which include one or more reviews for the identified items. In some cases, a generated review can be stored in memory corresponding to an item listing on an exchange platform. For example, storing a generated review in memory can include storing a review with a data element that indicates the generated review has first display settings when a user requests to view reviews for the item listing on the exchange platform. In some cases, a tag or other organizational techniques can be used to keep separation of real reviews from generated ones, e.g., a separate SQL table with a column that indicates it was generated. Generated review tables can be joined with existing review tables maintaining that column and allowing a distinction for any use case and additionally could point to some or all reference information used to generate the review.

In some implementations, the platform 102 maintains data corresponding to interactions or reviews for one or more items or one or more users. For example, the platform 102 can generate a user-specific review, a general review for a given item, or a review for a set of one or more users, or a combination of these. The platform 102 can generate an aggregated review using input data that represents one or more interactions by one or more users.

The search engine 110 provides search results 356 to the rank model 304. The rank model 304 generates ranked results 358 to the output engine 306 and the output engine 306 provides display results 360 indicating the ranked results 358 to the device 104 for display, as discussed.

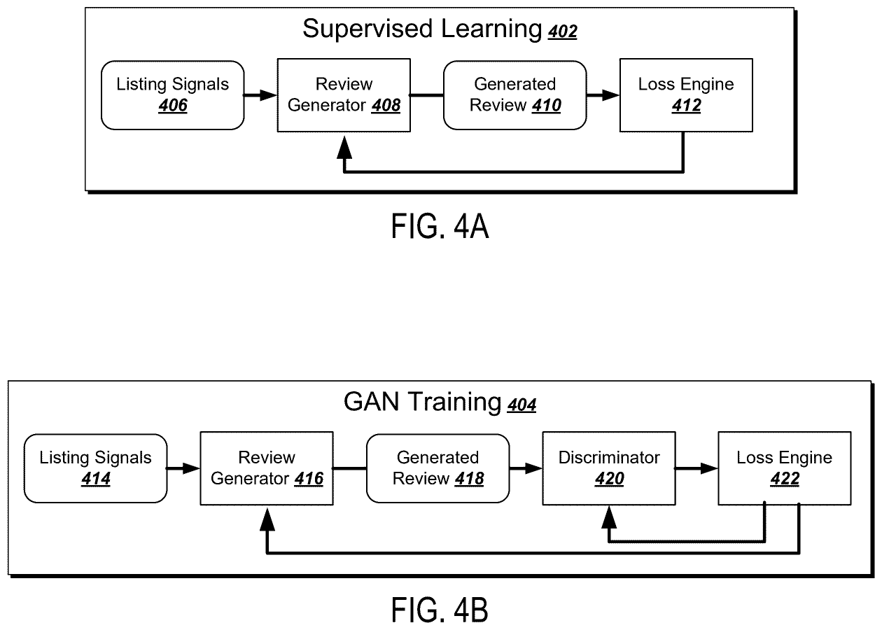

The process shown in FIG. 3C can improve search based on review data for an exchange platform that does not have many reviews or any reviews for one or more items. Search can improve by increasing the data used for search—e.g., by generating additional reviews. In some cases, the reviews can be extrapolated based on interactions with a given set of one or more items. If interactions indicate that the item is of high quality than a corresponding review will indicate such a likelihood. Training to generate models for generating such reviews are discussed in FIG. 4A and FIG. 4B.

In some cases, generated reviews are not visible to a user of the exchange platform 102. For example, the review generation engine 116 can generate a review that is stored with data corresponding to an item as a silent review. The generated review can be used for improving search as shown in FIG. 3C but is not shown to users. This can ensure that all reviews viewed by users are still provided by humans while also improving search based on additional review datasets.

In some cases, generated reviews, either edited or generated as is from the review generation engine 116, are shown to users of the exchange platform 102. For example, the review generation engine 116 can generate a review based on data of an item and that generated review can be posted by the exchange platform 102 to a review section of a listing page for an item. The review can be sent to a user for modification or approval prior to posting.

FIG. 4A and FIG. 4B show different training methods for training a review generator 408 and review generator 416, respectively. The review generators can be included in the review generation engine 116, e.g., after training using at least one of the training methods. The methods include a supervised learning method 402 and a generative adversarial network (GAN) training method 404.

In the supervised learning method 402, listing signals 406 are provided to the review generator 408. The listing signals 406 can correspond to an item listing with a known review generated by another process or by a human. The known review can then be used by a loss engine 412 to supervise the training of the review generator 408 as ground truth data.

The review generator 408 includes one or more machine learning models. The models can include one or more fully or partially connected layers with one or more nodes each. The review generator 408 generates a review 410 using the listing signals 406. The review 410 can be similar to the review for item A shown in FIG. 2. The review generator 408 can provide the review 410 to the loss engine 412. The loss engine 412 can be configured to compare the generated review 410 with data representing a ground truth review, e.g., a review written or approved by a human. The loss engine 412 can generate a loss value and use the loss value to adjust one or more weights or parameters of models used in the review generator 408. Training processes can include one or more of the following: stochastic gradient descent (SGD), mini-batch gradient descent, momentum, RMSprop, AdaGrad, or Adaptive Moment Estimation (ADAM).

In the GAN training method 404, listing signals 414 are associated with an item listing. The item listing may, or may not, have actual reviews written for them. The review generator 416 obtains the listing signals 414 and generates a review 418. The review can include similar elements to the review of item A in FIG. 2. The review generator 416 provides the generated review 418 to a discriminator 420. The discriminator 420 can include one or more models trained to discriminate between whether or not a review is generated by a human or by one or more models of the review generator 416. A loss engine 422 can be used to train the discriminator 420 and the review generator 416 such that the discriminator 420 improves in correctly identifying whether reviews were generated by a human or the generator 416. The loss engine 422 can obtain ground truth data indicating whether or not a given review was indeed generated by a human or a generator. The loss engine 422 can use this data together with data from the discriminator 420 to adjust one or more models of the discriminator 420 and the review generator 416.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for operating an exchange platform, the method comprising:
obtaining, using a script executing on a user device that displays first search results generated by a search engine for a user, data indicating interactions of the user with one or more items of the first search results;
generating, using a trained review generation engine and based on the obtained interaction data, a review that predicts content of a review of at least one of the one or more items generated by the user;
updating the search engine using the generated review; and
using the updated search engine to generate second search results for the user, wherein the second search results are different than the first search results.

2. The method of claim 1, wherein using the updated search engine to generate second search results for the user comprises:
obtaining item listings using a query analyzer engine in response to a user query; and
ranking the obtained item listings using a ranking engine.

3. The method of claim 2, wherein the ranking engine uses the generated review to rank the obtained item listings.

4. The method of claim 2, wherein the query analyzer engine uses the generated review to obtain the item listings.

5. The method of claim 1, wherein generating the review occurs during a same session as the display of the first search results.

6. The method of claim 1, wherein obtaining the interaction data comprises:
obtaining a signal indicating a user selection on a graphical user interface (GUI) of the user device.

7. The method of claim 1, wherein obtaining the interaction data comprises:
obtaining a signal indicating a mouse hovering over a portion of a graphical user interface (GUI) of the user device.

8. The method of claim 1, wherein obtaining the interaction data comprises:
obtaining at least one or more of the following: listing content, quality signals indicative of user interactions with the one or more items of the first search results, lister identification for the one or more items of the first search results, conversations between the user and lister for the one or more items of the first search results, shipping information, delivery information, search queries, search queries within a time range, or search queries within the same session.

9. The method of claim 1, comprising:
training the review generation engine using a supervised learning technique.

10. The method of claim 1, comprising:
training the review generation engine using an unsupervised learning technique.

11. The method of claim 1, wherein training the review generation engine comprises:
using a discriminator network to determine whether reviews generated by the review generation engine were generated by humans or not.

12. The method of claim 1, wherein the generated review includes a written portion in a language of the user.

13. The method of claim 1, wherein the generated review includes a rating portion indicating a rating of the at least one of the one or more items.

14. The method of claim 1, wherein updating the search engine using the generated review comprises adjusting one or more parameters of the search engine.

15. The method of claim 1, comprising:
receiving a first query and generating the first search results in response to receiving the first query; and
receiving a second query and generating the second search results in response to receiving the second query, wherein the first query and the second query are the same.

16. The method of claim 1, comprising:
providing the second search results to the user device.

17. A method comprising:
generating, using a trained review generation engine and based on obtained interaction data, a review that predicts content of a review for one or more items on an exchange platform;
providing data indicating the generated review to a first user device, wherein the data includes completed elements for a review of an item;
obtaining, from the first user device, a final review, wherein the final review is a modified version of the generated review;
storing the final review in memory corresponding to the item on the exchange platform; and
providing the final review to a second user device in response to the second user device navigating to a review section on a listing page for the item.

18. The method of claim 17, comprising:
training the review generation engine using a supervised learning technique.

19. The method of claim 17, comprising:
training the review generation engine using an unsupervised learning technique.

20. The method of claim 17, wherein the generated review includes a written portion in a language of the user.

21. The method of claim 17, wherein the generated review includes a rating portion indicating a rating of the at least one of the one or more items.

22. The method of claim 17, wherein the generated review includes a review portion that is the same as a review portion of the final review.

23. A method comprising:
obtaining, using a script executing on one or more user devices that display an item listing, data indicating interactions of one or more users with the item listing;
generating, using a trained review generation engine and based on the obtained interaction data, a review that predicts content of a review for the item listing;
storing the generated review in memory corresponding to the item listing on the exchange platform;
in response to a search query, obtaining, by a trained search engine, data including the stored generated review of the item listing;
providing search results generated by the trained search engine to a user device, wherein the search results include the item listing; and
in response to a request by the user device for reviews of the item listing, providing a set of reviews that does not include the generated review.

24. The method of claim 23, wherein obtaining the interaction data comprises:
obtaining a signal indicating a user selection on a graphical user interface (GUI) of the user device.

25. The method of claim 23, wherein obtaining the interaction data comprises:
obtaining a signal indicating a mouse hovering over a portion of a graphical user interface (GUI) of the user device.

26. The method of claim 23, comprising:
training the review generation engine using a supervised learning technique.

27. The method of claim 23, comprising:
training the review generation engine using an unsupervised learning technique.

28. The method of claim 23, wherein the generated review includes a written portion in a language of the user.

29. The method of claim 23, wherein the generated review includes a rating portion indicating a rating of the at least one of the one or more items.

30. The method of claim 23, wherein storing the generated review in memory corresponding to the item listing on the exchange platform comprises:
storing the generated review in memory with a data element that indicates the generated review has first display settings when a user requests to view reviews for the item listing on the exchange platform.
